(19) United States
(12) Patent Application Publication
(10) Pub. No.: US 2009/0292932 A1
(43) Pub. Date: Nov. 26, 2009

(54) DEVICE FOR MANAGING ELECTRONIC DEVICES CONSTITUTING STORAGE SYSTEM

(75) Inventors: Kazuhiro OYAMA, Ebina (JP); Ryu GEMBA, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/179,128

(22) Filed: Jul. 24, 2008

(30) Foreign Application Priority Data
May 23, 2008 (JP) 2008-135949

(51) Int. Cl. G06F 1/32

(52) U.S. Cl. 713/310

(57) ABSTRACT

A management device that manages a plurality of electronic devices constituting a storage system specifies a power effect unit, through which a path that cannot be closed does not pass, from among a plurality of power effect units present in the storage system (units whose power states are switched independently), and causes the power state of the power effect unit to be transitioned to a power savings state by closing the path passing through the power effect unit. The power effect units are units, the power states of which are switched independently, and are the electronic devices themselves or a part thereof.

### CROSS-REFERENCE TO PRIOR APPLICATION

This application relates to and claims the benefit of priority from Japanese Patent Application number 2008-135949, filed on May 23, 2008 the entire disclosure of which is incorporated herein by reference.

### BACKGROUND

The present invention generally relates to a technology for managing electronic devices which constitute a storage system.

As a storage system, a system which comprises a storage device (disk array device, for example) having a plurality of storage media drives, an upper-level device (host device, for example) of the storage device, and a switch device that is connected to the storage device and upper-level device, for example, is known.

Conventionally, several technologies for reducing the power consumption of a storage device are known.

For example, Japanese Application Laid Open No. 2008-041050 discloses a technology according to which a storage device comprises a repeater between a plurality of storage media drives (hard disk drives (HDD), for example) of different performance levels which are hierarchically disposed, the repeater reducing the power consumption of the storage device by stopping or starting up the storage media drives in accordance with preset conditions.

Furthermore, Japanese Application Laid Open No. 2007-102409 discloses a technology according to which the upper-level device connected to the storage device reduces the power consumption of the storage device by controlling the storage device in accordance with the operational state of an application running on the upper-level device.

### SUMMARY

According to Japanese Application Laid Open No. 2008-041050 and Japanese Application Laid Open No. 2007-102409 (referred to hereinbelow as the ‘prior art’ for the sake of convenience), it is possible to reduce the power consumption of only a storage device.

However, it is thought to be more desirable to be able to reduce the power consumption of electronic devices other than the storage device. This is because a further reduction in the power consumption of the whole storage system can be expected.

It is also considered desirable to be able to reduce the power consumption of the storage device by means of technology that is different from the prior art.

Furthermore, being able to reduce the power consumption of an electronic device can be expected to contribute to the longevity of the electronic device and, as a result, a reduction in the maintenance burden can be expected. More specifically, for example, the switch device is generally in a location spaced apart from the upper-level device and/or storage device. Hence, it is considered that, although it is necessary for the maintenance worker to move to this separate location to perform maintenance (replacement work, for example), if the frequency of the maintenance of the switch device is reduced due to the long life of the switch device, for example, the burden on the maintenance worker is reduced to the same degree.

It is therefore an object of the present invention to be able to reduce the power consumption of electronic devices other than the storage device.

A further object of the present invention is to be able to reduce the power consumption of the storage device using a technology which is different from the prior art.

A management device that manages a plurality of electronic devices constituting a storage system specifies a power effect unit through which a path not targeted for closure does not pass from among a plurality of power effect units present in the storage system and causes the power state of the power effect unit to transit to a power savings state by closing the path passing through the power effect unit.

More specifically, for example, the plurality of electronic devices include one or more storage devices, one or more upper-level devices (host devices, for example), and one or more switch devices. The one or more storage devices have one or more logical storage units and a plurality of storage ports which are a plurality of communication ports. The one or more upper-level devices have a plurality of upper-level ports which are a plurality of communication ports. The one or more switch devices have a plurality of switch ports which are a plurality of communication ports. The plurality of switch ports include switch ports of a first type that is connected to the upper-level ports and switch ports of a second type that is connected to the storage ports. The storage system has one or more multipaths formed therein. The multipaths are constituted by a plurality of paths linked to the same logical storage unit. The respective paths pass through the upper-level ports, the switch ports of a first type, the switch ports of a second type, and the storage ports. The respective electronic devices have one or more power effect units which are units the power states of which are switched independently. The power effect units of the electronic devices are related to communication ports which the electronic devices have and are the electronic devices themselves or a part of the electronic devices. The upper-level device uses any path of the plurality of paths which the upper-level device is managing to transmit an I/O request designating a logical storage unit, for example. The storage device accesses the logical storage unit designated by the I/O request in response to the I/O request.

The management device comprises a specification part, a path management part, and a power management part. The specification part specifies a first power effect unit the power state of which is an ON state from among the plurality of power effect units in the storage system. The path management part transmits a path closure instruction which is an instruction to close first paths which pass through the first power effect unit to the power effect unit having the upper-level port through which the first paths pass or to the upper-level device having the power effect unit. The power management part transmits a switching instruction to switch the power state of the first power effect unit to the power savings state to the first power effect unit or the electronic device having the first power effect unit. All of the respective first paths which pass through the first power effect unit are constituent elements of either multipath.

The transmission destination of the switching instruction may be an upper-level device, a power effect unit which the upper-level device has, a switch device, a power effect unit which the switch device has, a storage device, or a power effect unit which the storage device has. If the transmission destination of the switching instruction is a part other than the storage device or a power effect unit which the storage device has, the power consumption of the electronic devices other than the storage device can be reduced. If the transmission destination of the switching instruction is the storage device or a power effect unit which the storage device has, the power consumption of the storage device can be reduced using technology that is different from the prior art mentioned earlier.

At least one of the specification part, path management part, and power management part can be constructed by hardware, computer programs, or a combination thereof (for example, some of the parts are implemented by a computer program while the remaining parts are implemented by hardware). The computer program is read and executed by a predetermined processor. In addition, in the event of information processing in which a computer program is read and executed by a processor, a storage area that exists on a hardware resource such as memory may also be suitably used. In addition, a computer program may be installed on a computer from a recording medium such as a CD-ROM or downloaded to a computer via a communication network. The specification part, path management part, and power management part are parts which are provided in the power savings management unit 41 of subsequent embodiments, for example.

### BRIEF DESCRIPTION OF THE DRAWINGS

FIG. 1 shows a constitutional example of a computer system according to this embodiment;

FIG. 2 shows a constitutional example of a host device;

FIG. 3 shows a constitutional example of an FC switch;

FIG. 4 shows a constitutional example of a storage device;

FIG. 5 shows a constitutional example of a power savings management server;

FIG. 6 shows an example of a device table;

FIG. 7 shows an example of a host device table;

FIG. 8 shows an example of an FC switch table;

FIG. 9 shows an example of a storage device table;

FIG. 10 shows an example of a path table;

FIG. 11 shows a system constitution and system state prior to the start of power saving processing of a first example;

FIG. 12 shows a system constitution and system state after the end of power saving processing of the first example;

FIG. 13 shows a system constitution and system state prior to the start of power saving processing of a second example;

FIG. 14 shows a system constitution and system state after the end of power saving processing of the second example;

FIG. 15 is a flowchart for power saving processing; and

FIG. 16 is a flowchart of restore processing.

### DESCRIPTION OF THE PREFERRED EMBODIMENTS

An embodiment of the present invention will be described in detail hereinbelow with reference to the drawings.

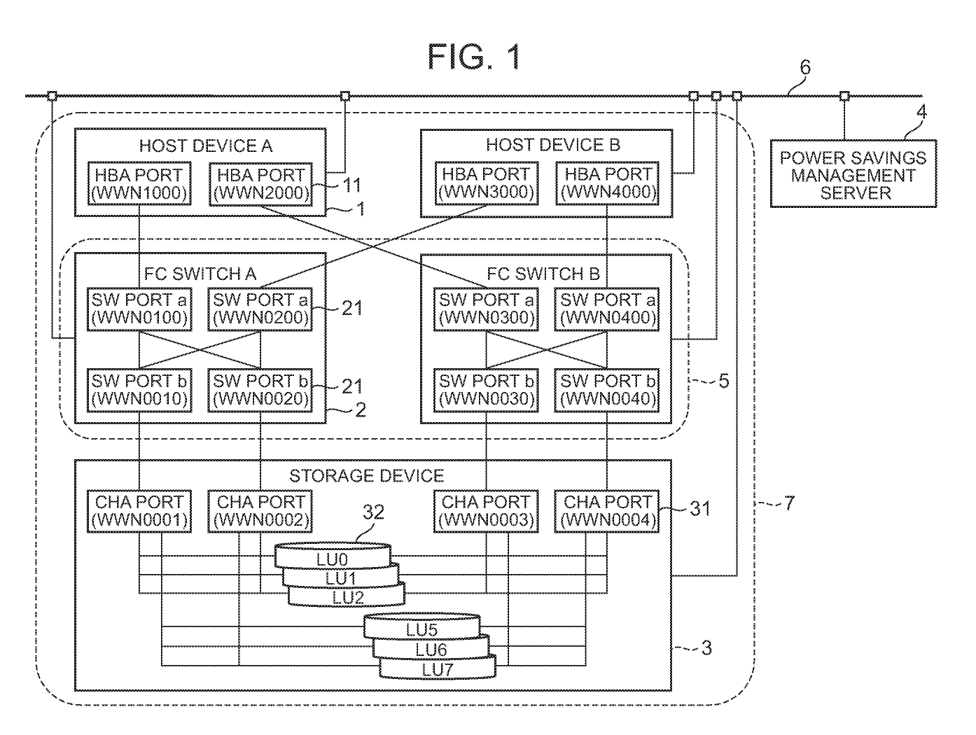

FIG. 1 shows a constitutional example of a computer system according to this embodiment.

The computer system has a storage system 7 and a power savings management server 4. Electronic devices (referred to as the ‘system constituent devices’ hereinbelow) which constitute the storage system 7 include one or more host devices 1, one or more fiber channel switches (‘FC switches’ hereinbelow) 2, and one or more storage devices 3. The SAN (Storage Area Network) is constituted by one or more FC switches 2. In this embodiment, as shown in FIG. 1, there are two host devices A and B for the one or more host devices 1 and two FC switches A and B for the one or more FC switches 2. In cases where the description distinguishes between the respective system constituent devices hereinbelow, the description makes reference to the host device A or host device B, and FC switch A or FC switch B rather than to the host devices 1 or FC switches 2.

The host devices 1 and storage device 3 are connected via a SAN 5 (that is, via at least one FC switch 2). The host devices 1, FC switches 2, storage device 3, and power savings management server 4 are connected via a management network (a LAN (Local Area Network), for example) 6.

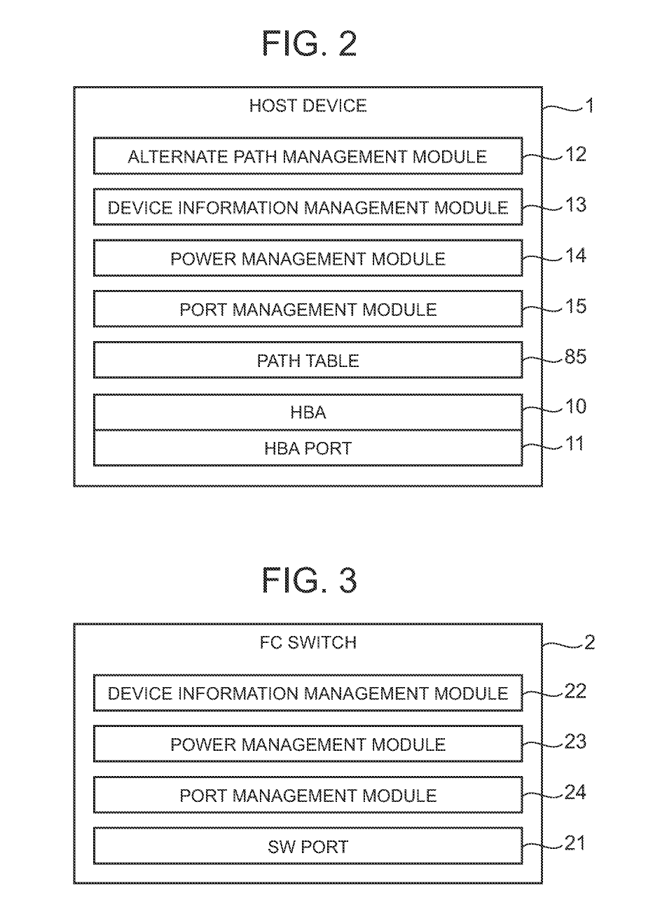

The host device 1 is a computer that accesses logical units (‘LU’ hereinbelow) 32 provided by the storage device 3. The host device 1 comprises one or more HBA (Host Bus Adapters) as interface devices for communication via the SAN 5, for example. One or more HBA have a plurality of HBA ports 11 which are connected to the SAN 5. The details of the internal constitution of the host device 1 will be described subsequently with reference to FIG. 2.

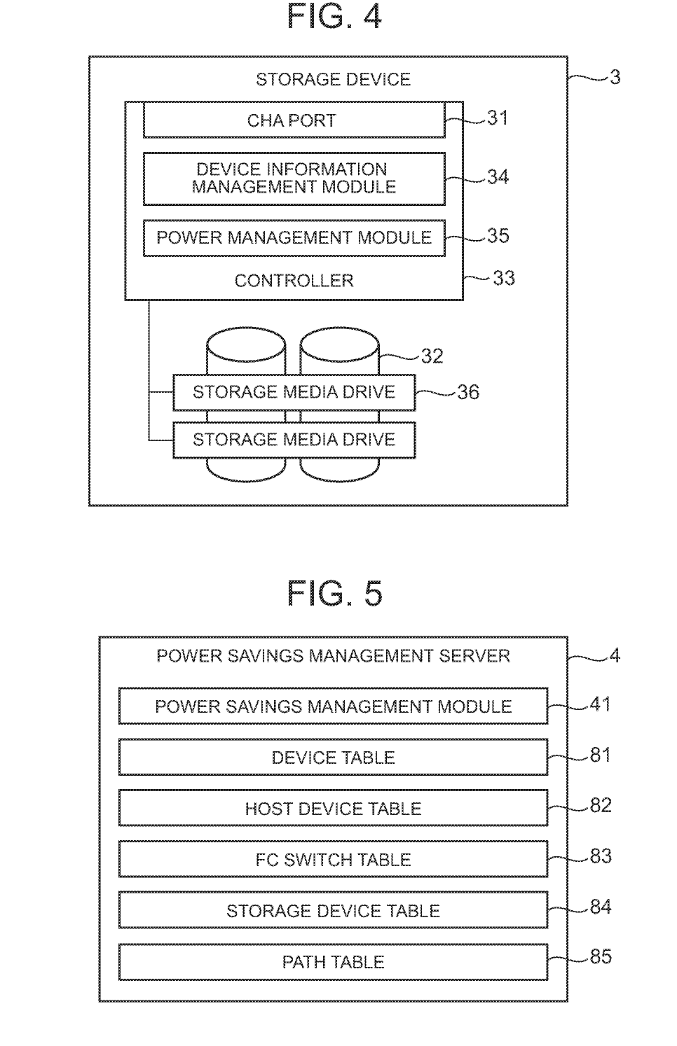

The storage device 3 can be a RAID (Redundant Arrays of Independent (or Inexpensive) Disks) system which comprises a plurality of arranged storage media drives (hard disk drives (HDD), for example), for example. The plurality of storage media drives are not limited to HDD and may also be constituted by storage media drives of another type (by flash memory drives, for example) or may be a mix of a storage media drives of a plurality of types. An LU 32 is formed by assigning a portion of the respective storage areas of the plurality of storage media drives at a time. An LU 32 is a logical storage device that is provided by the storage device 3 to the host device 1. The storage device 3 comprises a plurality of CHA (Channel Adapter) ports 31, for example, and each CHA port 31 is connected to the SAN 5. The details of the internal constitution of the storage device 3 will be provided subsequently with reference to FIG. 4.

The FC switch 2 is a device that constitutes the SAN 5, as mentioned earlier. The FC switch 2 is provided with a plurality of SW ports 21, for example. An HBA port 11 of the host device 1 or a CHA port 31 of the storage device 3 is connected to each SW port 21 (not only the HBA port 11 or CHA port 31 but also a SW port 21 of another FC switch 2 may be connected to the SW port 21). In this embodiment, an SW port 21 which is connected to the HBA port 11 is called an ‘SW port a’ and an SW port 21 which is connected to the CHA port 31 is called an ‘SW port b’. The details of the internal constitution of the FC switch 2 will be described subsequently with reference to FIG. 3.

The connections between the system constituent devices (host devices 1, FC switches 2, or storage device 3) are made by connecting the ports which the respective electronic devices comprise via cable (FC cable capable of data communication using the Fiber Channel system, for example). More specifically, the connections between the host devices 1 and FC switches 2 are made as a result of connecting one of the HBA ports 11 which the host devices 1 comprise and one of the SW ports a which the FC switches 2 comprise via cable. Similarly, the connections between the storage devices 3 and the FC switches 2 are made by connecting one of the CHA ports 31 which the storage devices 3 comprise and one of the SW ports b which the FC switches 2 comprise via cable. Multiple connections between the same system constituent devices can also be made by using a plurality of ports 11, 21 and 31 and cables. For example, in the example of FIG. 1, a connection between the storage device 3 and FC switch A is made by connecting the CHA port (WWN0001) and SW port b (WWN0010) and the CHA port A (WWN0001) and the SW port b (WWN0020) (a duplex connection). The character string in brackets assigned to each port name indicates the WWN (World Wide Name) which is the identifier of the port.

As a result of connecting the host device 1 and FC switch 2 and the storage device 3 and FC switch 2, a communication path that extends from the logical volume (not shown) which the host device 1 comprises to the LU 32 which the storage device 3 comprises that is mounted in the logical volume (referred to simply as a ‘communication path’ hereinbelow) is formed in the storage system 7. When described in specific terms via the example of FIG. 1, the server A and FC switch A are connected as a result of connecting the HBA port (WWN1000) which server A comprises and SW port a (WWN0100) which FC switch A comprises, for example. Furthermore, the storage device 3 and FC switch A are connected by connecting the CHA port (WWN0001) which the storage device 3 comprises and the SW port b (WWN0010) which the FC switch A comprises. Accordingly, a communication path that extends from the logical volume which the host device 1 comprises to the LU 32 (LU0 to LU7 in the example of FIG. 1) which the storage device 3 comprises via HBA port (WWN1000), SW port a (WWN0100), SW port b (WWN0010), and CHA port (WWN0001) is formed. In the example in FIG. 1, in addition to this communication path (the communication path which is connected to any of the LU0 to LU7 via HBA port (WWN 1000), SW port a (WWN0100), SW port b (WWN 0010), and CHA port (WWN0001)), a communication path which is connected to any of LU0 to LU7 via the HBA port (WWN2000), SW port a (WWN0300), SW port b (WWN0030), and CHA port (WWN0003), or the like, for example, is formed.

The power savings management server 4 is a computer that manages the states of the system constituent devices (the host devices 1, FC switches 2, and storage device 3). The power savings management server 4 is able to control the power states of power effect units of the system constituent devices. More specifically, the power savings management server 4 is able to switch the power states of the power effect units of the system constituent devices from an ON state to a power savings state or switch the power states of the power effect units from a power savings state to an ON state. Here, the ‘power effect units’ are units the power states of which can be changed independently, which have ports which the system constituent devices comprise and are the system constituent devices themselves or a portion of the devices. In this embodiment, for example, the power effect units of the host device 1 are the HBA ports 11 (strictly speaking, the circuit which comprises the HBA ports 11 in the HBA, for example), the power effect units of the storage device 3 are the CHA ports 31 (strictly speaking, the circuit comprising the CHA port 31 in the controller of the storage device 3, for example), and the power effect unit of the FC switch 2 is the whole FC switch 2. However, this is an example and there is no need to limit the power effect units to this example. For example, the power effect units of the host device 1 may be the HBA or the whole host device 1. Furthermore, the power effect unit of the storage device 3 may also be an interface circuit which comprises two or more CHA ports 31. The power effect units of the FC switch 2 may also be the SW ports 21 (strictly speaking the circuit which comprises the SW ports 21, for example).

The power savings management server 4 is able to reduce the power consumption of the whole storage system 7 by switching the power state of the power effect units of the system constituent devices from an ON state to a power savings state. The processing carried out by the power savings management server 4 to reduce the power consumption of the whole storage system 7 is called the ‘power savings processing’ hereinbelow. In the power savings processing, the power effect units which is the target for a switch to the power savings state (‘power savings target units’ hereinbelow) is predicated on there being no problems even in a power savings state (on there being no adverse effects on the storage system 7). The power savings processing and power savings target units will be described subsequently.

FIG. 2 shows a constitutional example of the host device 1.

The host device 1 comprises, in addition to the HBA 10 which comprises the HBA port 11, an alternate path management part 12, a device information management part 13, a power management part 14, a port management part 15, and a path table 85′, for example. The alternate path management part 12, device information management part 13, power management part 14, and port management part 15 constitute functions that are implemented as a result of loading and executing a computer program from memory (not shown) to the processor (not shown) in the host device 1, for example. However, all or some of at least one function may instead be rendered an integrated circuit or the like for implementation using hardware.

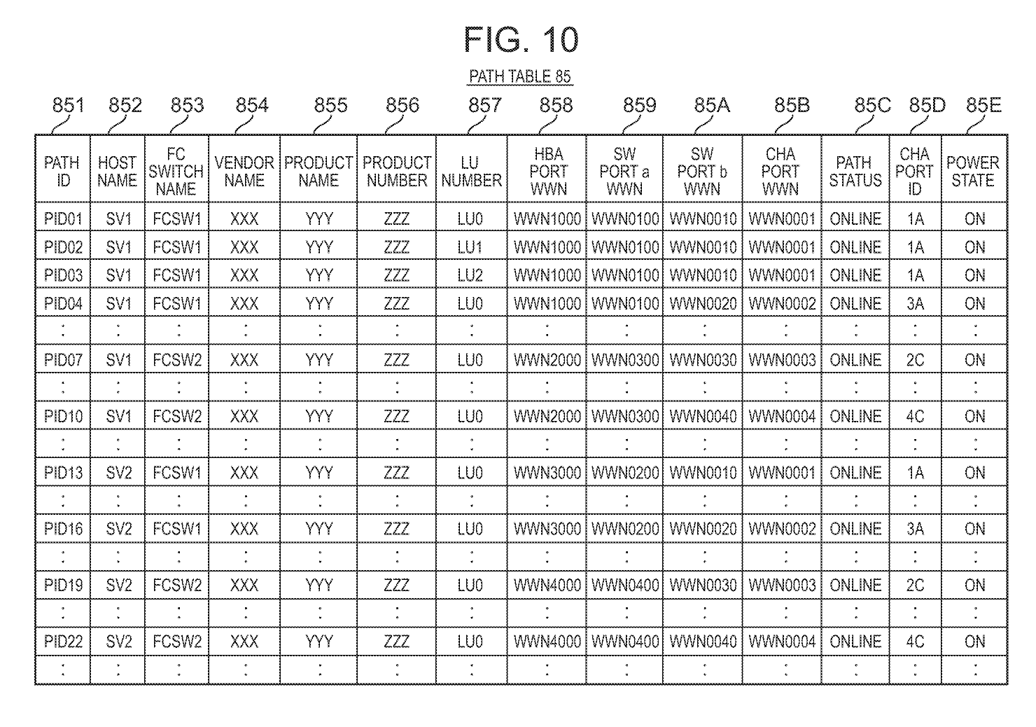

The alternate path management part 12 manages a communication path (alternate path in particular) that passes through the HBA port 11 which the host device 1 shown in FIG. 2 comprises. The ‘alternate path’ is another communication path of a multipath constituted by two communication paths, for example, and is a communication path which is available in cases where one communication path is closed. The path table 85′ is utilized in the management of the communication paths. The alternate path management part 12 acquires information required for the creation of the path table 85′ (the information for identifying the storage device 3 and the LU number or the like for identifying the LU, for example) from the storage device 3, and creates the path table 85′. The path table 85′ is information that is saved in the storage resources (memory, for example) in the host device 1, for example, and corresponds to part of the path table 85 (See FIG. 10) held by the power savings management server 4. More specifically, for example, a host name 852, FC switch name 853, HBA port WWN 858, SW port a WWN 859, SW port b WWN 85A and power state 85E, which are in the path table 85, are not included in the path table 85′. The alternate path management part 12 is able to transmit the path table 85′ to the power savings management server 4 in response to the path information request from the power savings management server 4.

Otherwise, the alternate path management part 12 is able to perform the following processing, for example. That is, in cases where a fault occurs in a communication path, the alternate path management part 12 is able to perform a switch from the communication path (the faulty path) to the alternate path. In addition, the alternate path management part 12 is able to distribute and transmit a plurality of I/O requests via a plurality of communication paths constituting the multipath (that is, perform I/O distribution) (in other words, a path load balance can be implemented). The alternate path management part 12 is also able to close an optional communication path.

The device information management part 13 manages information relating to the host device 1 (‘host information’ hereinbelow). Host information includes information assigned to the host device 1 such as the host name and IP address and information relating to the functions of the host device 1 such as power consumption, for example. The device information management part 13 communicates host information managed by another electronic device (the power savings management server 4, for example) in accordance with a host information acquisition request from the other electronic device to the electronic device which is the source of the acquisition request (or electronic device designated by the acquisition request).

The power management part 14 controls the power state of the host device 1. The power management part 14 is able to control the power state of the host device 1 itself and is able to control the power states of the individual devices (HBA ports 11, for example) which the host device 1 comprises. The control of the power states in the host device 1 is carried out in accordance with a switching instruction from the power savings management server 4. In response to the switching instruction, the power management part 14 switches the power state of the power effect unit (HBA port 11, for example) designated by the switching instruction to the power state designated by the switching instruction. For example, in cases where the power state of the designated power effect unit is switched to the power savings state, the power management part 14 saves a set of the ID of the power effect unit and information relating to the operating state thereof from the volatile memory to the involatile storage resource, and then shifts the designated power effect unit to the power savings state. Additionally, for example, in cases where the power state of the designated power effect unit is switched to an ON state, the power management part 14 shifts the power effect unit from a power savings state to an ON state and loads a set of the ID of the power effect unit and information relating to the operating state thereof from the involatile storage resource to the volatile memory. The processing relating to the switching of the power state is an example and the invention is not limited to this processing. For example, the processing of saving information relating to the operating state from the volatile memory to the involatile storage resource may also be dispensed with.

The port management part 15 performs management of information relating to the HBA port 11 (‘HBA port information’ hereinbelow). HBA port information includes information assigned to the HBA port 11 such as the WWN, information relating to the function of the HBA port 11 such as the maximum I/O amount, and information indicating states of the HBA port 11 such as the current I/O amount, for example. The maximum I/O amount of the HBA port 11 is the maximum value of the I/O amount which can be handled by the HBA port 11. The ‘I/O amount’ as it is intended in this embodiment is the amount of information flowing per unit of time (the amount of information transferred), that is, the information transfer rate. The port management part 15 transmits the managed port information to the power savings management server 4 in response to an HBA port information request from the power savings management server 4. The HBA port information may be managed by the HBA 10 and, in this case, the port management part 15 is able to issue a request for HBA port information to the HBA 10 in response to the HBA port information request and transfer HBA port information acquired from the HBA 10 to the power savings management server 4 in response to the request.

FIG. 3 shows a constitutional example of the FC switch 2.

In addition to the SW port 21 (SW port a and SW port b), the FC switch 2 comprises a device information management part 22, a power management part 23, and a port management part 24, for example. The device information management part 22, power management part 23 and port management part 24 are functions implemented as a result of loading and executing a computer program from memory (not shown) to the processor (not shown) in the FC switch 2, for example. However, all or some of the functions may instead be rendered an integrated circuit or the like for implementation using hardware.

The device information management part 22, power management part 23, and port management part 24 are substantially the same functions as the device information management part 13, power management part 14, and port management part 15 respectively in the host device 1.

That is, for example, the device information management part 22 manages information relating to the FC switch 2 (‘switch information’ hereinbelow). Switch information includes, for example, information assigned to the FC switch 2 such as the FC switch name and IP address and information relating to the function of the FC switch 2 such as the power consumption or the like. The device information management part 22 transmits the switch information to the power savings management server 4 in response to the switch information request from the power savings management server 4.

The power management part 23 controls the power states of the FC switch 2. In cases where the power management part 23 switches the power state of the FC switch 2 to a power savings state in response to a switching instruction from the power savings management server 4, the power management part 23 saves information relating to the operating state of the FC switch 2 from the volatile memory to the involatile storage resource and then shifts the FC switch 2 to a power savings state. Furthermore, for example, in cases where the power state of the FC switch 2 is switched to an ON state, the power management part 23 shifts the power effect units from the power savings state to an ON state and loads information relating to the operating state of the FC switch 2 from the involatile storage resource to the volatile memory.

The port management part 24 performs management of SW port information relating to the SW port 21 (WWN or maximum I/O amount or current I/O amount or the like). The port management part 24 transmits the SW port information to the power savings management server 4 in response to the SW port information request from the power savings management server 4.

FIG. 4 shows a constitutional example of the storage device 3.

The storage device 3 comprises a plurality of physical storage media drives (hard disk drives or flash memory devices and so forth) 36 and a controller 33 for controlling access to the plurality of physical storage media drives 36.

As mentioned earlier, a plurality of LU 32 are formed on the basis of the storage space provided by a plurality of storage media drives 36 (that is, a plurality of physical storage units).

The controller 33 comprises a plurality of CHA ports 31. The controller 33 receives I/O requests from the host device 1 via the CHA ports 31 and writes or reads data corresponding with the I/O request to and from the LU 32 designated by an I/O request. More specifically, for example, the controller 33 comprises one or more host interface circuits, one or more processors, one or more drive interface circuits, and one or more memories (including cache memory, for example). The host interface circuit comprises one or a plurality of CHA ports 31 and receives I/O requests from the host device 1. The drive interface circuit is a circuit that is connected to the storage media drive 36. The processor processes an I/O request received by the host interface circuit and accesses the storage media drive 36 which is based on the LU 32 designated by the I/O request via the drive interface circuit in accordance with the I/O request. Thereupon, the write target data or read target data corresponding with the I/O request are temporarily written to the cache memory and the data written to the cache memory are written to the storage media drive 36 or transmitted to the host device 1.

The controller 33 comprises a device information management part 34 and a power management part 35, for example. The device information management part 34 and power management part 35 are functions that are implemented as a result of loading and executing a computer program from memory (not shown) to the processor (not shown) in the controller 33, for example. However, all or some of the functions may instead be rendered an integrated circuit or the like for implementation using hardware.

The device information management part 34 and power management part 35 are functions that are substantially the same as the device information management part 15 and power management part 14 in the host device 1.

In other words, the device information management part 34 performs management of information relating to the storage device 3 (‘storage information’ hereinbelow). Storage information includes, for example, information for identifying the storage device 3 (vendor name, product name, product number and so forth) and information assigned to the storage device 3 such as the IP address and information relating to the performance of the storage device 3 such as the power consumption. The device information management part 34 transmits storage information to the power savings management server 4 in response to the storage information request from the power savings management server 4.

The power management part 35 controls the power state of the power effect units (CHA ports 31) in the storage device 3.

FIG. 5 shows a constitutional example of the power savings management server 4.

The power savings management server 4 comprises a power savings management part 41, a device table 81, a host device table 82, an FC switch table 83, a storage device table 84, and a path table 85, for example. The power savings management part 41 constitutes a function that is implemented as a result of loading and executing a computer program from memory (not shown) to the processor (not shown) in the power savings management server 4, for example. However, all or some of at least one function may instead be rendered an integrated circuit or the like for implementation using hardware. Tables 81 to 85 constitute information that is saved in the storage resource (memory, for example) in the power savings management server 4.

The power savings management part 41 executes the power saving processing on the basis of the various tables 81 to 85. The power savings management part 41 also creates the various tables 81 to 85. When creating the various tables 81 to 85, the power savings management part 41 acquires information required for the creation of the various tables 81 to 85 (host information, switch information, storage information, HBA port information, CHA port information, and so forth) from the electronic devices constituting the storage system 7.

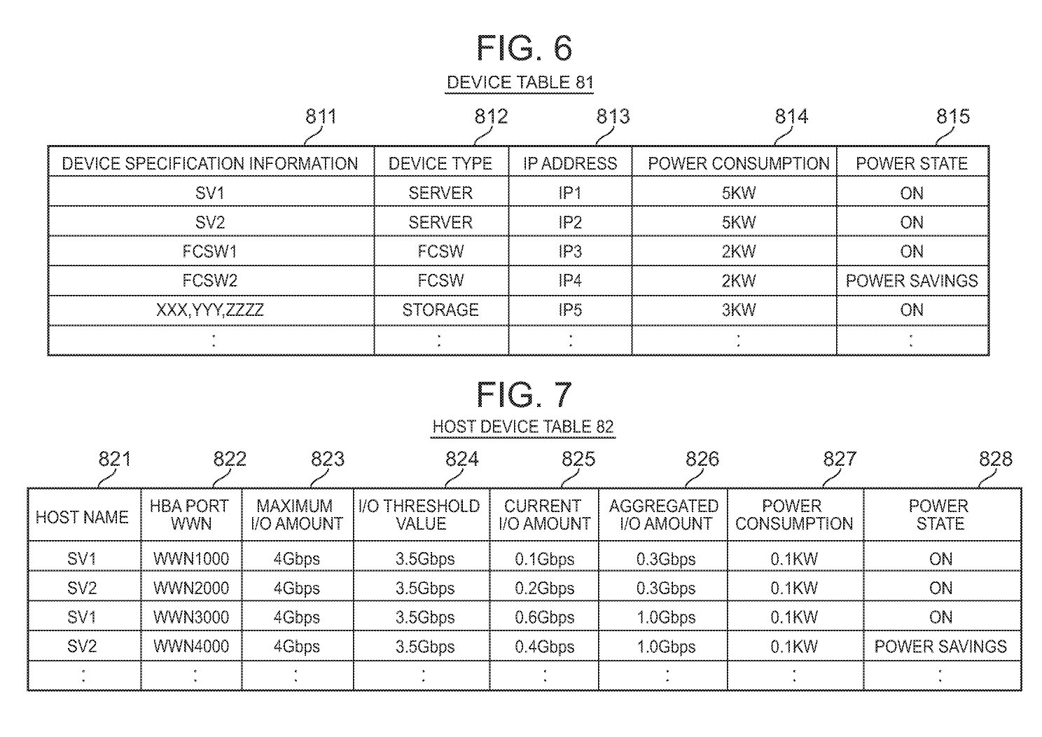

FIG. 6 shows an example of the device table 81.

The device table 81 is a table for managing information relating to the various system constituent devices. The device table 81 records, for each of the system constituent devices, device specification information 811, a device type 812, an IP address 813, power consumption 814, and a power state 815, for example. Various information items 811 to 815 will be described by taking one system constituent device (called a ‘target system constituent device’ in the description of FIG. 6 hereinbelow) hereinbelow as an example.

The device specification information 811 is information for uniquely specifying a target system constituent device. For example, in cases where the target system constituent device is host device 1, the device specification information 811 is the host name of the host device 1. Furthermore, in cases where the target system constituent device is the FC switch 2, the device specification information 811 is the FC switch name of the FC switch 2. Furthermore, in cases where the target system constituent device is the storage device 3, the device specification information 811 is information for identifying the storage device 3, that is, a combination of the vendor name, the product name and the product number.

The device type 812 is information indicating the type of the target system constituent device. For example, in cases where the target system constituent device is the host device 1, the device type 812 is the “Server”. In addition, in cases where the target system constituent device is the FC switch 2, the device type 812 is the “FCSW”. In addition, in cases where the target system constituent device is the storage device 3, the device type 812 is “Storage”.

The IP address 813 is an IP address that is assigned to the target system constituent device. The power savings management server 4 communicates with the target system constituent device by utilizing the IP address 813.

The power consumption 814 is the power consumption of the target system constituent device. The power consumption 814 may be a value that is presented as a specification of the target system constituent device or may be an actual measurement value. In cases where the power consumption 814 is an actual measurement value, the power savings management server 4 issues a power consumption inquiry to the target system constituent device at regular or irregular intervals. The target system constituent device, which receives the inquiry, reports the measured power consumption value to the power savings management server 4.

The power state 815 is information indicating the power state of the target system constituent device. For example, in cases where the power state of the target system constituent device is in an ON state, the power state 815 is then “ON”. However, in cases where the target system constituent device is in a power savings state, the power state 815 is then “power savings”.

FIG. 7 shows an example of the host device table 82.

The host device table 82 is a table for managing information (the HBA port information in this embodiment) relating to the power effect units (the HBA port 11 in this embodiment) of the host device 1. The host device table 82 stores, for each HBA port 11, for example, a host name 821, an HBA port WWN 822, a maximum I/O amount 823, an I/O threshold value 824, a current I/O amount 825, an aggregated I/O amount 826, power consumption 827, and power state 828. Information items 821 to 828 will be described by taking one HBA port (called the ‘target HBA port’ in the description of FIG. 7 hereinbelow) 11 as an example hereinbelow.

The host name 821 is the host name of the host device 1 comprising the target HBA port 11. The HBA port WWN 822 is the identifier (WWN) of the target HBA port 11. The maximum I/O amount 823 is the maximum I/O amount of the target HBA port

The I/O threshold value 824 is a reference value that is used in order to judge whether the target HBA port 11 is able (is allowed) to handle the aggregated I/O when the I/O aggregation is performed for the communication paths that pass through the target HBA port 11. In order to prevent excessive I/O aggregation, the I/O threshold value 824 is set at a value which is from 60 percent to 70 percent of the maximum I/O amount, for example.

The current I/O amount 825 is the I/O amount for each unit of time that is currently transferred by the target HBA port 11. The aggregated I/O amount 826 is a predictive value for the I/O amount of the target HBA port 11 following the I/O aggregation of the communication paths passing through the target HBA port 11. The power consumption 827 is the power consumption pertaining to the target HBA port 11. The power consumption 827 may be a value presented as a specification or may be an actual measured value as per the power consumption 814 of the device table 81. The power state 828 is information indicating the power state of the target HBA port 11. As per the power consumption 814 of the device table 81, the power state 828 is, for example, “ON”, or “power savings”.

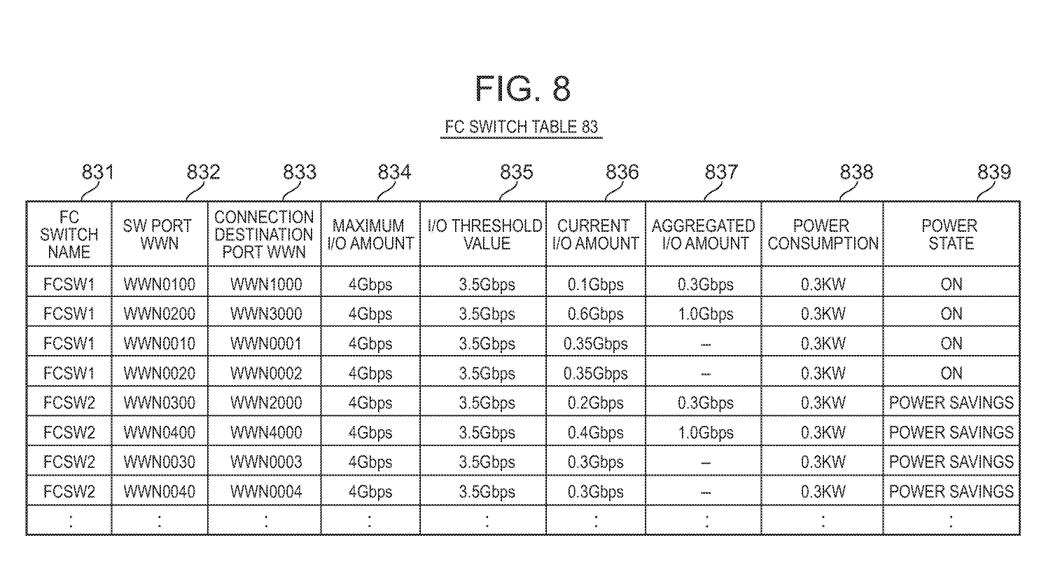

FIG. 8 shows an example of the FC switch table 83.

The FC switch table 83 is a table for managing information relating to the devices which the respective FC switches 2 constituting the storage system 7 comprise (in this embodiment, the SW ports 21 (SW port a and SW port b)). The FC switch table 83 stores, for example, the FC switch name 831, SW port WWN 832, connection destination port WWN 833, maximum I/O amount 834, I/O threshold value 835, current I/O amount 836, aggregated I/O amount 837, power consumption 838, and operating state 839. Information items 831 to 839 will be described hereinbelow by adopting one FC port (called the ‘target FC port’ in the description of FIG. 8 hereinbelow) 21 as an example.

The FC switch name 831 is the name of the FC switch 2 comprising the target SW port 21. The SW port WWN 832 is the identifier (WWN) of the target SW port 21. The connection destination port WWN 833 is the identifier (WWN) of the port (HBA port 11 or CHA port 31) connected via cable to the target SW port 21.

The other information item 834 to 839 are substantially the same content as the information items 823 to 828 of the host device table 82. In other words, the maximum I/O amount 834 is the maximum I/O amount of the target SW port 21. The I/O threshold value 835 is a reference value that is used in order to judge whether the target SW port 21 is capable of handling the aggregated I/O when I/O aggregation is performed with respect to the communication paths passing through the target SW port 21. The current I/O amount 836 is the I/O amount per unit of time that is currently being transferred by the target SW port 21. The aggregated I/O amount 837 is a predictive value for the I/O amount of the target SW port 21 following the I/O aggregation with respect to the communication paths passing through the target SW port 21. The power consumption 838 is the power consumption of the target SW port 21. The power state 839 is information indicating the power state of the FC switch 2 which comprises the target SW port 21. If the power effect unit of the FC switch 2 is the target SW port 21, the power state 839 is information representing the power state of the target SW port 21.

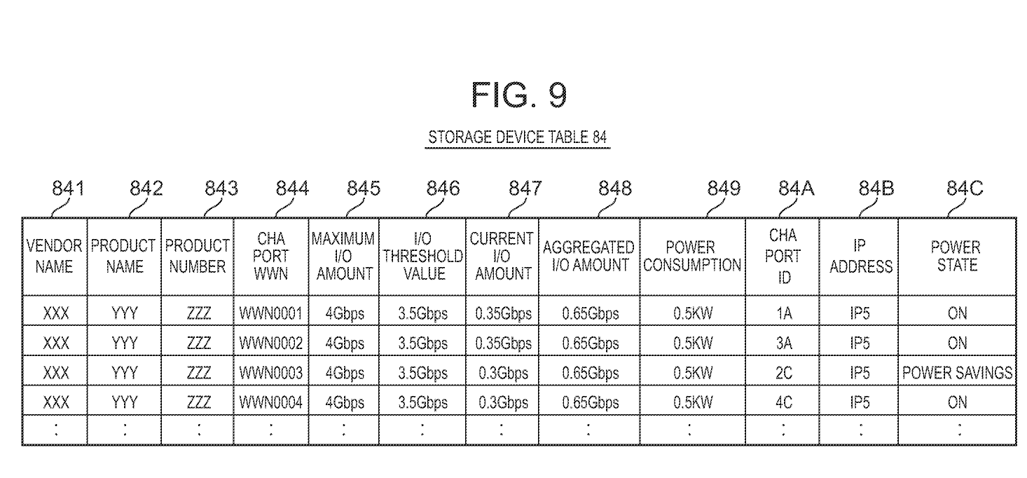

FIG. 9 shows an example of the storage device table 84.

The storage device table 84 is a table for managing information relating to the power effect units of the storage device 3 (the CHA port 31 in this embodiment). The storage device table 84 stores, for example, for each CHA port 31, a vendor name 841, a product name 842, a product number 843, a CHA port WWN 844, a maximum I/O amount 845, an I/O threshold value 846, a current I/O amount 847, an aggregated I/O amount 848, power consumption 849, a CHA port 84A, and a power state 84B. Information items 841 to 84C will be described hereinbelow for one CHA port (called the ‘target CHA port’ in the description of FIG. 9 hereinbelow) 31.

The vendor name 841 is the vendor name of the storage device 3 which comprises the target CHA port 31. The product name 842 is the product name of the storage device 3 which comprises the target CHA port 31. The product number 843 is the product number of the storage device 3 which comprises the target CHA port 31. The CHA port WWN 844 is the identifier (WWN) of the target CHA port 31. The CHA port ID is another identifier of the target CHA port 31. The IP address 84B is the IP address assigned to the target CHA port 31.

The other information items 845 to 849 and 84C are substantially the same as the information items 823 to 828 in the host device table 82. That is, the maximum I/O amount 845 is the maximum I/O amount of the target CHA port 31. The I/O threshold value 846 is a reference value that is used in order to judge whether the target CHA port 31 is capable of handling the aggregated I/O when I/O aggregation is performed with respect to the communication path that passes through the target CHA port 31. The current I/O amount 847 is the I/O amount per unit of time that is currently transferred by the target CHA port 31. The aggregated I/O amount 848 is a predictive value for the I/O amount of the target CHA port 31 following the I/O aggregation with respect to the communication paths that pass through the target CHA port 31. The power consumption 849 is the power consumption of the target CHA port 31. The power state 84B is information indicating the power state of the target CHA port 31.

FIG. 10 shows an example of the path table 85.

The path table 85 is a table for managing a plurality of communication paths formed in the storage system 7. The path table 85 stores, for each communication path, for example, a path ID 851, the host name 852, FC switch name 853, vendor name 854, product name 855, product number 856, LU number 857, HBA port WWN 858, SW port a WWN 859, SW port b WWN 85A, CHA port WWN 85B, path status 85C, CHA port 85D, and power state 85E. Information items 851 to 85E will be described hereinbelow by adopting one communication path (called the ‘target communication path’ in the description of FIG. 10 hereinbelow) as an example.

The path ID 851 is an identifier for uniquely specifying a target communication path. The host name 852 is the name of the host device 1 which comprises the HBA port 11 through which the target communication path passes. The FC switch name 853 is the name of the FC switch 2 which comprises the SW port 21 through which the target communication path passes. The vendor name 854, product name 855, and product number 856 are the vendor name, product name, and product number respectively of the storage device 3 which comprises the CHA port 31 through which the target communication path passes.

The LU number 857 is the LU number of the LU 32 connected to the target communication path. The HBA port WWN 858 is the identifier (WWN) of the HBA port 11 through which the target communication path passes. The SW port a WWN 859 is the identifier (WWN) of the SW port a through which the target communication path passes. The SW port b WWN 85A is the identifier (WWN) of the SW port b through which the target communication path passes. The CHA port WWN 85B is the identifier (WWN) of the CHA port 31 through which the target communication path passes.

The path status 85C is information indicating the status of the target communication path. For example, the path status 85C is “Online” in cases where the target communication path is available, “Offline” in cases where the target communication path is closed, and “fault” in cases where a fault occurs in the target communication path.

The power state 85E is information indicating the power state relating to the target communication path. More specifically, for example, whereas the power state 85E is “power savings” in cases where at least one of the plurality of power effect units through which the target communication path passes is in a power saving state, the power state 85E is “ON” in cases where the power states of all of the plurality of power effect units are ON states.

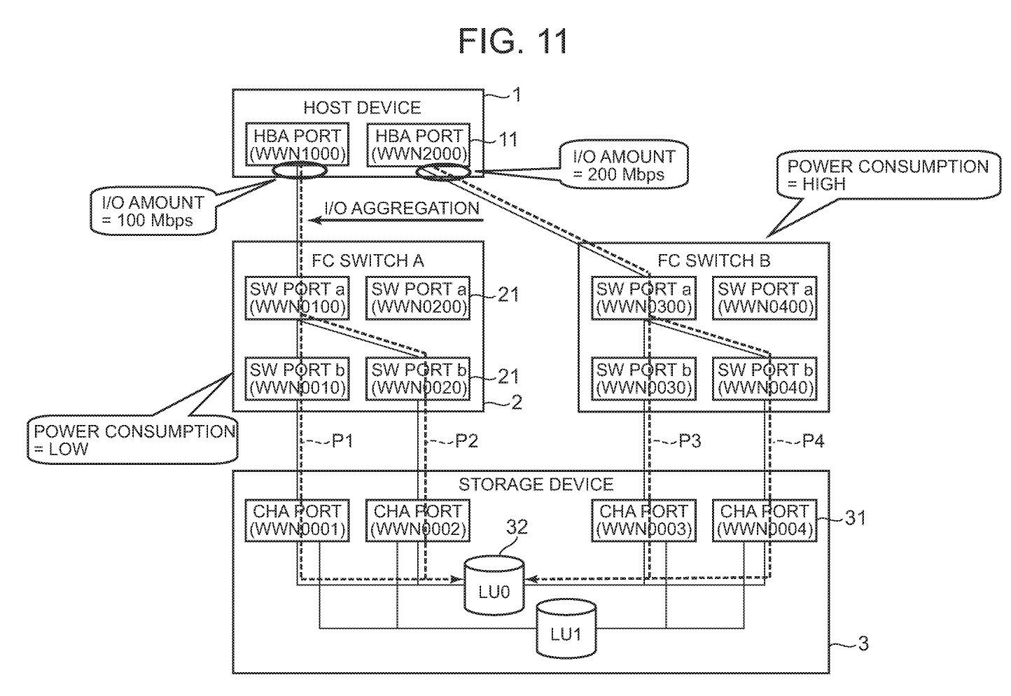

The constitution of the computer system according to this embodiment was described hereinabove. Details of the power savings processing performed by the power savings management server 4 according to this embodiment will be described hereinbelow with reference to FIGS. 11 to 16. First, a description of the power savings processing will be provided via FIGS. 11 to 14 by citing two specific examples.

FIG. 11 shows a system constitution and system state prior to the start of power saving processing of a first example.

Here, ‘system constitution’ is the constitution of the storage system 7 and refers, more specifically, to what kind of system constituent devices the storage system 7 is constituted by, what kind of performance each system constituent device exhibits, and what kind of communication paths are formed in the storage system 7, and so forth, for example. Furthermore, the ‘system state’ is the state of the storage system 7 and refers, more specifically, to what kind of power states the various power effect units are in, and the nature of the status of each communication path, for example. The information indicating the system constitution and the information indicating the system state are managed by the various tables 81 to 85 which the power savings management server 4 comprises.

First, the system constitution of the first example will be described. As shown in FIG. 11, the storage system 7 is constituted by one host device 1, two FC switches A and B, and one storage device 3. Further, the host device 1 comprises two HBA ports (WWN 1000) and (WWN 2000). Furthermore, the FC switch A comprises four SW ports a, namely SW port a (WWN0100), SW port a (WWN0200), SW port b (WWN0010), and SW port b (WWN0020). In addition, the FC switch B comprises four SW port a (WWN0300), SW port a (WWN0400), SW port b (WWN0030), and SW port b (WWN0040). In addition, the storage device 3 comprises four CHA ports, namely a CHA port (WWN0001), a CHA port (WWN0002), a CHA port (WWN0003), and a CHA port (WWN0004). Furthermore, the storage system 7 has four communication paths P1 to P4 as shown in FIG. 11 formed therein. These four communication paths P1 to P4 are communication paths that extend from the same logical volume (not shown) to the same LU0. That is, the respective communication paths P1 to P4 are the constituent elements of a multipath. Furthermore, the power consumption of the FC switch B is higher than the power consumption of the FC switch A.

The system state of the first example will be described next. The HBA port (WWN1000) through which the communication paths P1 and P2 pass has a current I/O amount (that is, the I/O amount transferred as a result of either or both of the communication paths P1 and P2 being used) of “100 Mbps”. In addition, the HBA port (WWN2000) through which the communication paths P3 and P4 pass has a current I/O amount (that is, the I/O amount transferred as a result of either or both of the communication paths P3 and P4 being used) of “200 Mbps”.

In the system constitution and system state of the first example, the power savings management server 4 is able to execute the power savings processing as follows, for example.

That is, the power savings management server 4 first selects the FC switch B with the higher power consumption (that is, the FC switch for which the power savings effect is thought to be greater) as a candidate for the power savings target unit. The power savings management server 4 then judges whether it is possible to switch the power state of the selected FC switch B to the power savings state. That is, the power savings management server 4 judges whether it is possible to close all of the communication paths P3 and P4 which pass through the FC switch B.

As mentioned earlier, in cases where the closure target paths P3 and P4 in this case are multipath constituent elements and the HBA port (WWN1000) through which the alternate paths P1 and P2 corresponding with the closure target paths P3 and P4 pass permit aggregated I/O, it is judged that the closure target paths P3 and P4 can be closed. More specifically, in cases where the aggregated I/O amount 826 “300 Mbps” (the total I/O amount of the current I/O amount “200 Mpbs” of the HBA port (W2000) through which the closure target paths P3 and P4 pass and the current I/O amount “100 Mbps” of the HBA port (WWN1000) (that is, the I/O amount of the aggregated I/O)) does not exceed the I/O threshold value 824 (See FIG. 7) of the HBA port (WWN1000), it is judged that the closure target paths P3 and P4 can be closed. The judgment of whether ports other than the HBA port (WWN1000), namely, the SW port a (WWN0100), SW port b (WWN0010), SW port b (WWN0020), CHA port (WWN0001) and CHA port (WWN0002) through which the alternate paths P1 and P2 pass permit aggregated I/O is not necessarily required. This is because, in cases where it is judged that the HBA port (WWN1000) which is the port which is located the furthest upstream permits aggregated I/O, it can be assumed that the port which is the furthest downstream also permits aggregated I/O.

In cases where it is judged that it is possible to close the closure target paths P3 and P4, the power savings management server 4 determines the FC switch B as a power savings target unit. When the power savings target unit is determined, the power savings management server 4 issues a switching instruction to switch the power state to a power savings state to the power savings target unit (FC switch B) after closing all of the communication paths (P3 and P4) which pass through the power savings target unit (FC switch B).

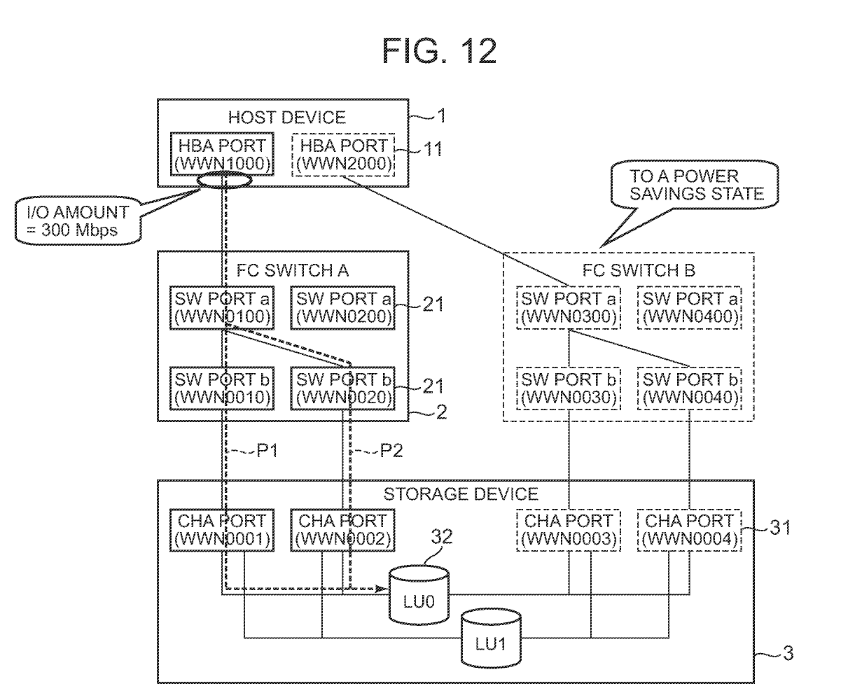

FIG. 12 shows a system constitution and system state after the end of power saving processing of the first example.

As shown in FIG. 12, the power state of the FC switch B enters a power savings state and the power consumption consumed by the FC switch B is reduced. The I/O amount of the HBA port (WWN1000) is “300 Mbps”.

The power savings management part 41 in the power savings management server 4 is also able to switch the HBA port (WWN2000), CHA port (WWN0003), and CHA port (WWN0004), through which the closed communication paths P3 and P4 pass, to a power savings state because unclosed communication paths do not pass therethrough according to this first example.

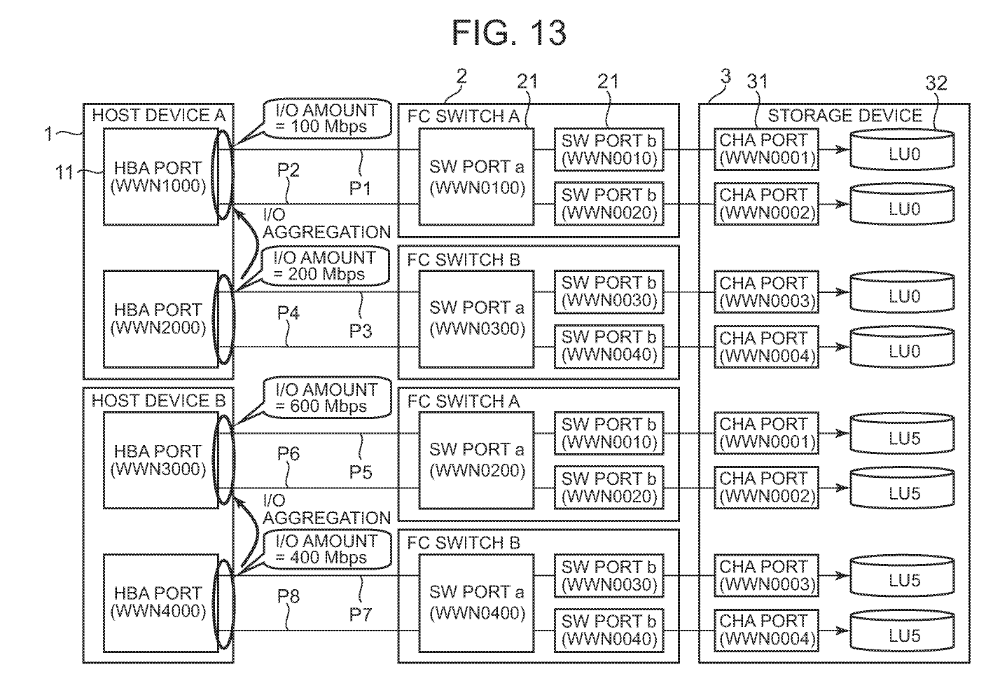

FIG. 13 shows the system constitution and system state prior to the start of power saving processing of the second example.

First, the system constitution of the second example will be described. As shown in FIG. 13, the storage system 7 is constituted by two host devices A and B, two FC switches A and B, and one storage device 3. That is, the second example differs from the first example in that the two host devices A and B are provided. Two of each of the FC switches A and B are mounted, parts with the same name representing the same parts respectively (the SW port b and CHA port 31 are also the same). The host device A comprises two HBA ports (WWN1000) and (WWN2000) Furthermore, the host device B comprises two HBA ports (WWN3000) and (WWN4000). Ports 21 and 31 which the FC switch A, FC switch B, and storage device 3 respectively comprise are the same as in the case of the first example.

In the second example, the storage system 7 has, in addition to the four communication paths P1 to P4 of the first example, four communication paths P5 to P8 (that is, a total of eight communication paths) formed therein. Furthermore, in addition to communication paths P1 and P2, communication paths P5 and P6 pass through an FC switch A. Further, in addition to communication paths P3 and P4, communication paths P7 and P8 pass through an FC switch B. Among these eight communication paths, communication paths P1 to P4 are communication paths which extend from the same logical volume to the same LU0 in the same way as the case of the first example and are constituent elements of a first multipath. In addition, communication paths P5 to P8 are also communication paths which extend from the same logical volume to the same LU5 and are constituent elements of a second multipath. Where the power consumption of FC switch 2 is concerned, the power consumption of the FC switch B is higher than the power consumption of the FC switch A as per the case of the first example.

The system state of the second example will be described next. The current I/O amount of the HBA port (WWN1000) through which communication paths P1 and P2 pass and the current I/O amount of the HBA port (WWN2000) through which communication paths P3 and P4 pass are the same as the case of the first example (that is, the former is “100 Mbps” and the latter is “200 Mbps”) The current I/O amount of the HBA port (WWN3000) through which communication paths P5 and P6 pass (that is, the I/O amount transferred as a result of utilizing one or both of communication paths P5 and P6) is “600 Mbps”. In addition, the current I/O amount of the HBA port (WWN4000) through which communication paths P7 and P8 pass (that is, the I/O amount transferred as a result of utilizing either communication path P7 or P8) is “400 Mbps”.

In the system constitution and system state of the second example, the power savings management server 4 is able to execute power savings processing as follows, for example.

That is, the power savings management server 4 first selects the FC switch B with the higher power consumption as a candidate for the power savings target unit (this point is the same as the case of the first example). The power savings management server 4 then judges whether it is possible to switch the power state of the selected FC switch B to the power savings state. That is, the power savings management server 4 judges whether it is possible to close all of the communication paths P3, P4, P7, and P8 which pass through the FC switch B.

As mentioned earlier, in cases where the first closure target communication paths P3 and P4 are constituent elements of the first multipath and the HBA port (W1000) through which first alternate paths P1 and P2 for the first closure target paths P3 and P4 pass permits aggregated I/O, it is judged that the first closure target paths P3 and P4 can be closed. Likewise, in cases where the second closure target paths P7 and P8 are constituent elements of the second multipath and the HBA port (WWN3000) through which the second alternate paths P5 and P6 for the second closure target paths P7 and P8 pass permits aggregated I/O, it is judged that the second closure target paths P7 and P8 can be closed.

It is judged whether the first closure target paths P3 and P4 can be closed in the same way as the case of the first example. That is, in cases where the I/O amount “300 Mbps” of the aggregated I/O (the total value of the current I/O “100 Mbps” of the HBA port (WWN2000) through which the first closure target paths P3 and P4 pass and the current I/O amount “200 Mbps” of the HBA port (W1000)) does not exceed the I/O threshold value of the HBA port (W1000), it is judged that the first closure target paths P3 and P4 can be closed.

It is judged whether the second closure target paths P7 and P8 can be closed as follows, for example.

That is, the second closure target paths P7 and P8 are constituent elements of the second multipath and the alternate paths are the communication paths P5 and P6. Hence, in cases where the I/O amount “1000 Mbps” of the aggregated I/O (the total value of the current I/O amount “400 Mbps” of the HBA port (WWN4000) through which the second closure target paths P7 and P8 pass and the current I/O amount “600 Mbps” of the HBA port (WWN 3000)) does not exceed the I/O threshold value of the HBA port (WWN3000) through which the alternate paths P5 and P6 pass, it is judged that the second closure target paths P7 and P8 can be closed.

In cases where it is judged that all of the first closure target paths P3 and P4 and the second closure target paths P7 and P8 can be closed, the power savings management server 4 determines the FC switch B as the power savings target unit. When the power savings target unit is determined, the power savings management server 4 issues a switching instruction to switch the power state to a power savings state to the power savings target unit (switch B) after closing all of the communication paths (communication paths P3 and P4 and communication paths P7 and P8) that pass through the power savings target unit (FC switch B).

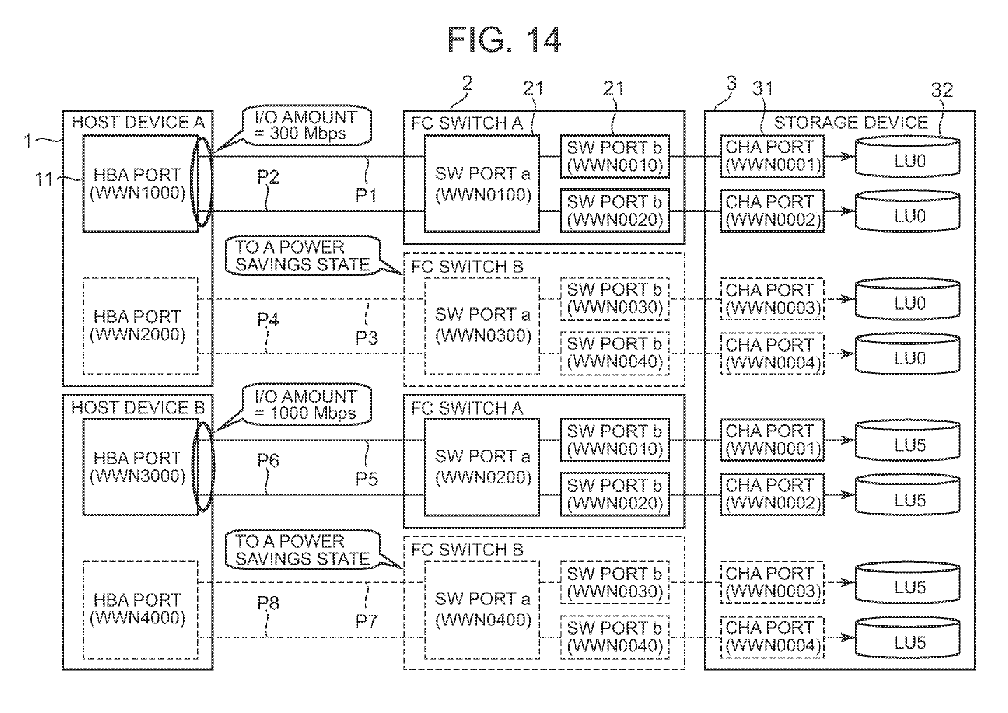

FIG. 14 shows a system constitution and system state after the end of power saving processing of the second example.

As shown in FIG. 14, the power state of the FC switch B enters a power savings state and the power consumption consumed by the FC switch B is reduced. The I/O amount of the HBA port (WWN1000) is“300 Mbps” and the I/O amount of the HBA port (WWN3000) is “1000 Mbps”.

The power savings management part 41 in the power savings management server 4 is able to switch the HBA port (WWN2000), CHA port (WWN0003), and CHA port (WWN0004) through which the first closure target paths P3 and P4 pass and the HBA port (WWN4000), CHA port (WWN0003), and CHA port (WWN0004) through which the second closure target paths P5 and P6 pass to a power savings state because unclosed communication paths do not pass therethrough according to this second example.

The details of the flow of the power savings processing will be described hereinbelow by using a flowchart.

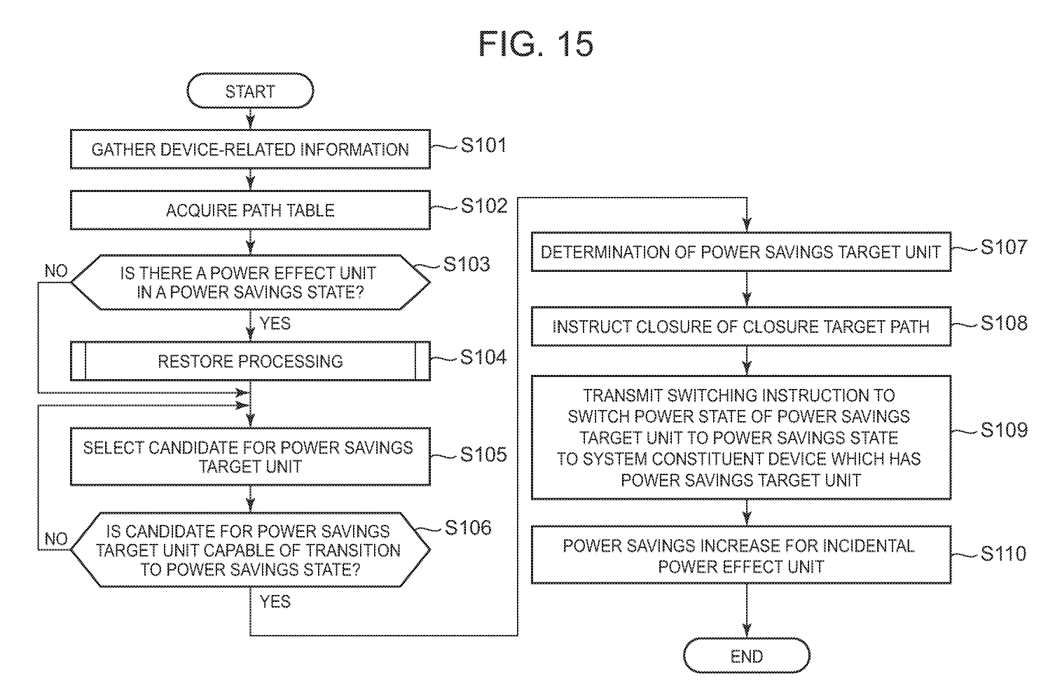

FIG. 15 is a flowchart of the power savings processing performed by the power savings management server 4.

First, the power savings management part 41 of the power savings management server 4 gathers information from the respective system constituent devices (S101). More specifically, the power savings management part 41 acquires the host information and HBA port information from the respective host devices 1 by transmitting a host information request and an HBA port information request to the respective host devices 1. Further, the power savings management part 41 acquires switch information and SW port information from the respective FC switches 2 by transmitting a switch information request and SW port information request to the respective FC switches 2. The power savings management part 41 also acquires storage information and CHA port information from the storage device 3 by transmitting a storage information request and CHA port information request to the storage device 3.

The power savings management part 41 creates a device table 81, host device table 82, FC switch table 83, and storage device table 84 on the basis of the information collected in S101 (the host information, switch information, storage information, and various port information). The power savings management part 41 is able to set the values designated by the administrator, for example, as the respective I/O threshold values 824, 835, and 846 of the host device table 82, FC switch table 83, and storage device table 84.

The power savings management part 41 then acquires the path table 85 (S102). More specifically, the power savings management part 41 acquires the path table 85′ from the respective host devices 1 and, based on the table 85′ and information relating to the transmission source of the table 85′, writes information items 851 to 857 and 85B to 85D (See FIG. 10) for each communication path to the path table 85. Furthermore, the power savings management part 41 writes the HBA port WWN 858, SW port a WWN 859, and SW port b WWN 85A to the path table 85 on the basis of the SW port WWN 832 and connection destination port WWN 833 in the FC switch table 83. As a result, path table 85 is completed.

In cases where the various tables 81 to 85 have already been created in S101 and S102 above, an update to any of tables 81 to 85 may also be performed.

The power savings management part 41 then judges whether there exists a power effect unit in the power savings state among the plurality of power effect units of the storage system 7 (S103). In specific terms, the power savings management part 41 judges whether a power effect unit in the power savings state exists by referencing the power state 815 of the device table 81, the power state 828 of the host device table 82, the power state 839 of the FC switch table 83, and the power state 84B of the storage device table 84.

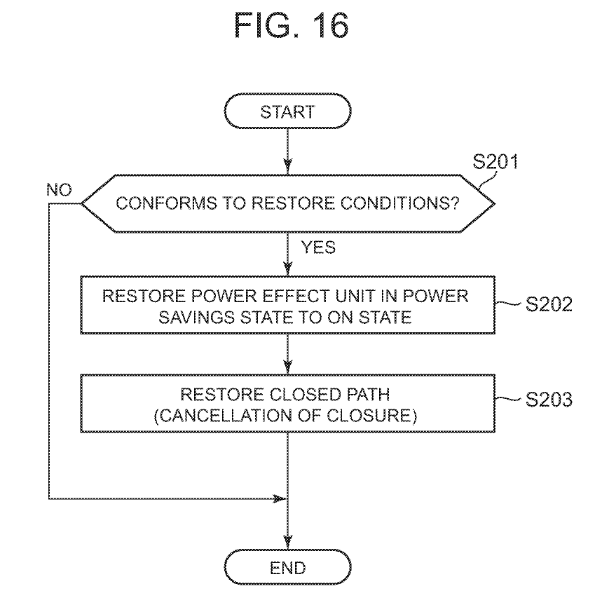

In cases where there exists a power effect unit in the power savings state (S103: YES), the power savings management part 41 performs processing (‘restore processing’ hereinbelow) to restore the power effect unit (that is, restore the power state thereof to an ON state) that has been switched to the power savings state in the power savings processing that is carried out before this power savings processing (S104). The details of the restore processing will subsequently be described with reference to FIG. 16.

However, in cases where there is no power effect unit in the power savings state (S103: NO), the power savings management part 41 determines the power savings target unit and performs processing to switch the power state of the determined power savings target unit to a power savings state.

More specifically, for example, the power savings management part 41 references the device table 81 and selects a candidate for the power savings target unit (one or a plurality of FC switches 2 in this example) (S105). The power savings management part 41 is able to adopt the following references, for example. Only any one of a plurality of references may be adopted or a plurality of references maybe adopted and a candidate for the power savings target unit may be selected by reviewing the respective results of the plurality of references.

<Reference 1: Power Consumption>

According to reference 1, the power savings management part 41 references the power consumption 814 of the device table 41 and selects the FC switch 2 with the largest power consumption possible as a candidate for the power savings target unit. A higher power savings result can accordingly be expected.

<Reference 2: Current I/O amount (I/O Amount During Transfer)>

According to reference 2, the power savings management part 41 references the current I/O amount 834 of the FC switch table 83 and selects the FC switch 2 with the smallest possible current I/O amount 834 (the FC switch 2 which the smallest possible total value of the current I/O amount 834 of the plurality of SW ports) as a candidate for the power savings target unit. As a result, the largest possible reduction in the I/O amount of the aggregated I/O can be expected. In cases where reference 1 is adopted in addition to reference 2, for example, in cases where a plurality of FC switches 2 whose power consumption is the same exist, the FC switch 2 with the smallest current I/O amount among the plurality of plurality of FC switches 2 is selected as a candidate for the power savings target.

<Reference 3: Number of Communication Paths>

According to reference 3, the power savings management part 41 references the FC switch name 853 of the path table 85 and selects the FC switch 2 with as few communication paths passing therethrough as possible (the FC switch 2 with the smallest possible number of registrations of the FC switch name 853 of the path table 85) as a candidate for the power savings target unit. As a result, the number of closed communication paths can be reduced as much as possible.

<Reference 4: The Number of Power Effect Units (or the Power Consumption Amount) Capable of Making the Transition to a Power Savings State in Sync>

According to reference 4, the power savings management part 41 selects, as a candidate for the power savings target unit, the FC switch 2 with the greatest possible number of power effect units (‘incidental power effect units’ hereinbelow) capable of making the transition to a power savings state in sync (or the total power consumption amount) in the transition to the power savings state of the FC switch 2. More specifically, for example, the power consumption of the storage system 7 can be reduced as much as possible and, when a reduction of the power consumption is of a higher priority than increasing the lifespan of the power effect unit, the FC switch 2 for which the total power consumption amount of the incidental power effect units is as large as possible is selected as a candidate for the power savings target unit irrespective of the number of incidental power effect units. Furthermore, in cases where a longer lifespan for the power effect unit is of a higher priority than reducing the power consumption of the storage system 7 as much as possible, the FC switch 2 with the largest possible number of incidental power effect units is selected as a candidate for the power savings target unit irrespective of the total power consumption amount of the incidental power effect units. When the number of incidental power effect units (or the total power consumption amount) is the same for a plurality of FC switches 2 which can serve as candidates for the power savings target unit, the FC switch 2 for which the total power consumption amount of the incidental power effect units (or number thereof) is as large as possible is selected as a candidate for the power savings target unit.

Let us now return to the description of the flowchart.

The power savings management part 41 judges whether the candidate for the power savings target unit (the selected FC switch 2) is able to switch a power state to a power savings state (S106). The details of this judgment will be described with reference to FIGS. 11 to 14.

In cases where it is judged that the candidate for the power savings target unit is incapable of switching to the power savings state (S106: NO), the power savings management part 41 performs the processing of S105 once again. That is, the power savings management part 41 once again makes a selection of a candidate for the power savings target unit. The FC switch 2 which has already been judged in S106 to be incapable of switching to a power savings state is excluded from the candidates for selection.

However, in cases where it is judged that the candidate for the power savings target unit is capable of switching to the power savings state (S106: YES), the power savings management part 41 determines the selected FC switch 2 as the power savings target unit (S107).

Thereafter, the power savings management part 41 issues a path closure instruction to close the closure target path to the host device 1 which comprises the HBA port 11 through which the closure target path passes for all of the respective communication paths (closure target paths) passing through the FC switch 2 determined as the power savings target unit (S108). The alternate path management part 12 of the host device 1 that receives the path closure instruction makes settings to close the communication path designated by the path closure instruction (more specifically, the status of the communication path in the path table 85′ is changed from “online” to “offline”). As a result, the closure target path is closed.

Subsequently (more specifically, for example, after notification of the end of the closure of the closure target path is received from the host device 1 which is the transmission destination of the path closure instruction), the power savings management part 41 issues a switching instruction to switch the power state to the power savings state to the FC switch 2 determined as the power savings target unit (S109). The power management part 23 of the FC switch 2 that receives the switching instruction switches the power state of the FC switch 2 to the power savings state.

Thereafter (more specifically, for example, after notification of the end of switching to the power savings state is received from the FC switch 2 which is the transmission destination of the switching instruction), the power savings management part 41 issues a switching instruction to switch the power states of the incidental power effect units which correspond with the FC switch 2 determined as the power savings target unit to the power savings state to the system constituent device 1 or 3 which comprises the incidental power effect units (S110). The power management part 14 or 35 in the system constituent device 1 or 3 which receives the switching instruction switches the power state of the power effect unit (HBA port 11 or CHA port 31) designated by the switching instruction to the power savings state.

The incidental power effect units are power effect units which are capable of making the transition to the power savings state in sync in the transition to the power savings state of the FC switch 2, as mentioned earlier. Therefore, for example, a power effect unit through which a closed communication path passes (that is, an “offline” communication path) and through which a communication path that is not closed (that is, an“online” communication path) also passes is not an incidental power effect unit. An incidental power effect unit can be specified by referencing the path table 85. More specifically, for example, the power savings management part 41 grasps the HBA port WWN 858 and CHA port WWN 85B from the row in the path table 85 which corresponds with the closure target path. If the HBA port WWN 858 also exists in the row corresponding with the unclosed path, the HBA port which corresponds with the HBA port WWN 858 is not an incidental power effect unit. However, if the HBA port WWN 858 is not also present in the row which corresponds with the unclosed path, the HBA port which corresponds with the HBA port WWN 858 is an incidental power effect unit (the same is also true of the CHA port WWN 85B that has been grasped).

FIG. 16 is a flowchart of restore processing.

The power savings management part 41 judges whether a power effect unit in the power savings state conforms to the restore conditions (S201). The restore conditions are at least one of the following (Condition 1) and/or (Condition 2), for example:
(Condition 1): a fault arises in any of K (where K is a natural number) alternate paths which correspond with the closed communication path;
(Condition 2): the current I/O amount of at least one port among the HBA port 11, SW port 21, and CHA port 31 through which the alternate path passes exceeds the I/O threshold value of the port. The occurrence of a fault in an alternate path can be grasped as a result of the power savings management part 4 issuing an inquiry regarding the status of the respective paths to the respective alternate path management parts 12 at regular intervals, for example.

The power savings management part 41 issues a switching instruction to switch the power state of the power effect unit to an ON state to the system constituent device which comprises the power effect unit which conforms to the restore conditions (S202). In response to the switching instruction, the power management unit 14, 23, or 35 in the system constituent device 1, 2, or 3 which receives the switching instruction switches the power state of the power effect unit 11, 21, or 31 designated by the switching instruction to an ON state.

The power savings management part 41 issues, for all of the respective communication paths passing through the power effect unit which conforms to the restore conditions, an instruction to the host device 1 which comprises the HBA port 11 through which the communication paths pass to cancel the closure of the communication paths of the host device 1 (S203). The alternate path management part 12 in the host device 1 which receives the closure cancellation instruction cancels the closure of the communication paths designated by the closure cancellation instruction (more specifically, switches the status of the communication paths from “offline” to “online”).

Details of the flow of the power savings processing including the restore processing were provided hereinabove.

The power savings management part 41 may also select a certain FC switch 2 as a candidate for the power savings target unit if the current time reaches a preset time for the FC switch 2 instead of or in addition to references 1 to 4 above. Likewise, the power savings management part 41 may make a certain power effect unit a power effect unit which conforms to the restore conditions if the current time reaches a preset time for the power effect unit instead of or in addition to conditions 1 and 2 above.

The embodiments of the present invention hereinabove are illustrations which serve to describe the present invention and there is no intention to limit the scope of the present invention to these embodiments. The present invention can be implemented in a variety of other forms without departing from the spirit of the present invention. For example, the FC switches 2 may also be connected to the storage system 7. The storage system 7 is not limited to the Fiber Channel protocol and may also perform I/O by means of another type of protocol (that is, a switch device of another type may also be adopted instead of the FC switch 2). Furthermore, a switching instruction to switch the power state of the HBA port 11 may be transmitted to the HBA 10 which comprises the HBA port 11 and the HBA 10 may switch the power state of the HBA port 11 in accordance with the switching instruction. In addition, the current I/O amounts of the respective communication paths may be managed by the path table 85. In this case, the I/O amount of a closure target path is added to the current I/O amount of the HBA port 11 through which the alternate path corresponding with the closure target path passes and it is judged whether closure of the closure target path is possible depending on whether the I/O amount following this addition exceeds the I/O threshold value of the HBA port 11. Furthermore, for example, the power savings management part 41 may also carry out the judgment of S103 in FIG. 15 each time an I/O request is issued by using an unclosed communication path.

What is claimed is:

1. A management device that manages a plurality of electronic devices constituting a storage system,
the plurality of electronic devices including one or more storage devices, one or more upper-level devices, and one or more switch devices,
the one or more storage devices having: one or more logical storage units; and a plurality of storage ports which are a plurality of communication ports,
the one or more upper-level devices having a plurality of upper-level ports which are a plurality of communication ports,
the one or more switch devices having a plurality of switch ports which are a plurality of communication ports; the plurality of switch ports including a switch port of a first type connected to the upper-level ports and a switch port of a second type connected to the storage ports,
the storage system having one or more multipaths formed therein, the multipaths being constituted by a plurality of paths linked to the same logical storage unit, and the respective paths passing through the upper-level ports, the switch port of a first type, the switch port of a second type, and the storage ports,
the respective electronic devices having one or more power effect units which are units, power states of which are switched independently;
the power effect units of the electronic devices being related to communication ports of the electronic devices and being the electronic devices themselves or a part of the electronic devices,
the management device comprising:
a specification part that specifies a first power effect unit, the power state of which is an ON state from among the plurality of power effect units in the storage system;
a path management part that transmits a path closure instruction, which is an instruction to close a first path passing through the first power effect unit, to the power effect unit having the upper-level port through which the first path passes, or to the upper-level device having the power effect unit; and
a power management part that transmits a switching instruction to switch the power state of the first power effect unit to the power savings state to the first power effect unit or the electronic device having the first power effect unit, wherein
all of the respective first paths which pass through the first power effect unit are constituent elements of either multipath.

2. The management device according to claim 1, wherein
the first power effect unit is any power effect unit among a plurality of power effect units of a first type, the power effect units of a first type being the switch devices or a part of the switch devices;
the specification part has a selection sub-part that selects a power effect unit candidate to be transitioned to a power savings state, and a judgment sub-part that judges whether it is possible to close all of the first paths passing through the selected candidate;
the first power effect unit is the candidate in cases where an affirmative judgment result is obtained;
the judgment sub-part judges that it is possible to close the first paths passing through the selected candidate in cases where an aggregated information amount per unit of time does not exceed a threshold value associated with the power effect unit, through which a second path of the multipath including the first path that passes through the candidate passes;
the aggregated information amount per unit of time is the total value of the information amount per unit of time flowing through the candidate or the first path that passes through the candidate and the information amount per unit of time flowing through the power effect unit, through which the second path passes;
the specification part further specifies a second power effect unit, through which the first path targeted for closure passes, and through which a path which is not targeted for closure does not pass;
the power management part transmits a switching instruction to switch the power state of the second power effect unit to a power savings state to the second power effect unit or to an electronic device which comprises the second power effect unit;
the second power effect unit is the upper-level device or a part thereof, and/or the storage device or a part thereof;
the first power effect unit corresponds to at least one of (2-1) to (2-5) below:
(2-1) a power effect unit of a first type for which the power consumption is higher than that for the other power effect unit of a first type;
(2-2) a power effect unit of a first type for which the information amount flowing per unit of time is smaller than that for the other power effect unit of a first type;
(2-3) a power effect unit of a first type for which the number of first paths passing therethrough is smaller than that for the other power effect unit of a first type;
(2-4) a power effect unit of a first type for which the number of the corresponding second power effect units or the total power consumption amount is smaller than those for the other power effect unit of a first type; and
(2-5) a power effect unit of a first type for which the current time has reached a preset time.

3. The management device according to claim 2, wherein
the specification part specifies a third power effect unit in a power savings state, which satisfies at least one of (3-1) to (3-3) below:
(3-1) a fault has occurred in any of K (where K is a natural number) second paths which correspond with a closed first path;
(3-2) the information per unit of time flowing through at least one communication port among an upper-level port, a switch port of a first type, a switch port of a second type, and a storage port, through which a second path passes, exceeds a threshold value associated with the communication port; and
(3-3) a power effect unit for which the current time has reached a preset time, and wherein
the power management part transmits a switching instruction to switch the power state to an ON state to the third power effect unit or to an electronic device which comprises the third power effect unit; and
the path management part transmits an instruction to cancel the closure of the closed first path to the power effect unit which has the upper-level port, through which the first path passes, or to the upper-level device which has the power effect unit.

4. The management device according to claim 2, wherein the first power effect unit is a power effect unit that satisfies (2-1) and at least one of (2-2) to (2-4) above.

5. The management device according to claim 2, wherein the judgment sub-part judges that it is possible to close the first paths passing through the selected candidate in cases where the aggregated information amount per unit of time does not exceed a threshold value associated with the upper-level port, through which a second path of the multipath including the first path that passes through the candidate passes.

6. The management device according to claim 1, wherein the first power effect unit is a power effect unit of a first type for which the power consumption is higher than that for the other power effect unit of a first type.

7. The management device according to claim 1, wherein the first power effect unit is a power effect unit of a first type for which the information amount flowing per unit of time is smaller than that for the other power effect unit of a first type.

8. The management device according to claim 1, wherein the first power effect unit is a power effect unit of a first type for which the number of first paths passing therethrough is smaller than that for the other power effect unit of a first type.

9. The management device according to claim 1, wherein
the specification part further specifies a second power effect unit, through which the first path targeted for closure passes, and through which a path which is not targeted for closure does not pass; and
the power management part transmits a switching instruction to switch the power state of the second power effect unit to a power savings state to the second power effect unit or to an electronic device which comprises the second power effect unit.

10. The management device according to claim 1, wherein the first power effect unit is a power effect unit of a first type for which the number of the corresponding second power effect units or the total power consumption amount is smaller than those for the other power effect unit of a first type.

11. The management device according to claim 1, wherein the specification part specifies a third power effect unit in a power savings state which satisfies (11-1) and/or (11-2) below:
(11-1) a fault has occurred in any of K (where K is a natural number) second paths which correspond with a closed first path;
(11-2) the information per unit of time flowing through at least one communication port among an upper-level port, a switch port of a first type, a switch port of a second type, and a storage port, through which a second path passes, exceeds a threshold value associated with the communication port;
the power management part transmits a switching instruction to switch the power state to an ON state to the third power effect unit or to an electronic device which comprises the third power effect unit; and
the path management part transmits an instruction to cancel the closure of the closed first path to the power effect unit which has the upper-level port, through which the first path passes, or to the upper-level device which has the power effect unit.

12. The management device according to claim 1, wherein
the specification part has a selection sub-part that selects a power effect unit candidate to be transitioned to a power savings state, and a judgment sub-part that judges whether it is possible to close all of the first paths passing through the selected candidate;
the first power effect unit is the candidate in cases where an affirmative judgment result is obtained;
the judgment sub-part judges that it is possible to close the first paths passing through the selected candidate in cases where the aggregated information amount per unit of time does not exceed a threshold value associated with the power effect unit, through which a second path of the multipath including the first path that passes through the candidate passes; and
the aggregated information amount per unit of time is the total value of the information amount per unit of time flowing through the candidate or the first path that passes through the candidate and the information amount per unit of time flowing through the power effect unit, through which the second path passes.

13. The management device according to claim 12, wherein the judgment sub-part judges that it is possible to close the first paths passing through the selected candidate in cases where the aggregated information amount per unit of time does not exceed a threshold value associated with the upper-level port, through which a second path of the multipath including the first path that passes through the candidate passes.

14. A method that manages a plurality of electronic devices constituting a storage system,
the plurality of electronic devices including one or more storage devices, one or more upper-level devices, and one or more switch devices,
the one or more storage devices having; one or more logical storage units; and a plurality of storage ports which are a plurality of communication ports,
the one or more upper-level devices having a plurality of upper-level ports which are a plurality of communication ports,
the one or more switch devices having a plurality of switch ports which are a plurality of communication ports; the plurality of switch ports including a switch port of a first type that is connected to the upper-level ports and a switch port of a second type that is connected to the storage ports,
the storage system having one or more multipaths formed therein, the multipaths being constituted by a plurality of paths linked to the same logical storage unit and the respective paths passing through the upper-level ports, the switch port of a first type, the switch port of a second type, and the storage ports,
the respective electronic devices having one or more power effect units which are units, the power states of which are switched independently,
the power effect units of the electronic devices having communication ports of the electronic devices and being the electronic devices themselves or a part of the electronic devices,
the method comprising the steps of:
specifying a first power effect unit, the power state of which is an ON state, from among the plurality of power effect units in the storage system, all of the respective first paths passing through the first power effect unit being constituent elements of any of multipaths;
transmitting a path closure instruction, which is an instruction to close a first path which passes through the first power effect unit, to the power effect unit having the upper-level port through which the first path passes, or to the upper-level device having the power effect unit; and
transmitting a switching instruction to switch the power state of the first power effect unit to the power savings state to the first power effect unit or the electronic device having the first power effect unit.

15. A computer program for causing a computer to execute management of a plurality of electronic devices constituting a storage system,
the plurality of electronic devices including one or more storage devices, one or more upper-level devices, and one or more switch devices,
the one or more storage devices having one or more logical storage units and a plurality of storage ports which are a plurality of communication ports,
the one or more upper-level devices having a plurality of upper-level ports which are a plurality of communication ports,
the one or more switch devices having a plurality of switch ports which are a plurality of communication ports, the plurality of switch ports including a switch port of a first type connected to the upper-level ports and a switch port of a second type connected to the storage ports,
the storage system having one or more multipaths formed therein, the multipaths being constituted by a plurality of paths linked to the same logical storage unit and the respective paths passing through the upper-level ports, the switch port of a first type, the switch port of a second type, and the storage ports,
the respective electronic devices having one or more power effect units which are units, the power states of which are switched independently;
the power effect units of the electronic devices having communication ports of the electronic devices and being the electronic devices themselves or a part of the electronic devices,
the computer program:
specifying a first power effect unit, the power state of which is an ON state, from among the plurality of power effect units in the storage system, all of the respective first paths passing through the first power effect unit being constituent elements of any of multipaths;
transmitting a path closure instruction, which is an instruction to close a first path which passes through the first power effect unit, to the power effect unit having the upper-level port through which the first path passes, or to the upper-level device having the power effect unit; and
transmitting a switching instruction to switch the power state of the first power effect unit to the power savings state to the first power effect unit or the electronic device having the first power effect unit.
